(19) United States
(12) Patent Application Publication
(10) Pub. No.: US 2002/0150440 A1
(43) Pub. Date: Oct. 17, 2002

(54) Wrapped shift washer

(76) Inventor: John D. Pratt, Laguna Niguel, CA (US)

Correspondence Address: TBGB&M, 36th Floor, 105 W. Adams, Chicago, IL, 60603, US

(21) Appl. No.: 09/834,439

(22) Filed: Apr. 13, 2001

(51) Int. Cl. F16B 13/04

(52) U.S. Cl. 411/43

(57) ABSTRACT

A shift washer which is used in a blind fastening system. The shift washer is made using a process of wrapping a piece of wire stock around a mandrel. This process provides significant cost advantages compared to the process of machining the shift washer. A flange can be provided on the shift washer to prevent the shift washers from nesting with one another and results in easier assembly of the blind fasteners.

### BACKGROUND OF THE INVENTION

This invention is generally directed to a shift washer which is used in a blind fastening system. More particularly, the invention contemplates a shift washer which is cost efficiently manufactured and provides for easier assembly of the blind fastener. A related application entitled “Wrapped Driving Anvil” was filed on Apr. 13, 2001 and is owned by the assignee of this application.

Blind fastening systems are designed to allow work pieces to be fastened together without requiring access to the rear or “blind” side of the work pieces. An example of such a blind fastening system is shown and described in U.S. Pat. No. 3,937,123 to Matuschek which was assigned to the assignee of the present invention.

As shown in FIGS. 1-4, the prior art blind fastener 18 is installed by passing a sleeve 20 and a stem 22 of the fastener 18 through holes in the work pieces 24, 26 so that a tail 28 of the stem 22 protrudes through the rear or blind side of the work pieces 24, 26. A head portion 30 of the sleeve 20 is enlarged to prevent the sleeve 20 from passing entirely through the work pieces 24, 26.

As described in the Matuschek '123 patent, fasteners 18 are installed using an ordinary push-pull type installation tool. The installation tool generally includes a gripping member 32 which grips and pulls the end of the stem 22 which protrudes from the head portion 30 of the sleeve 20 and an anvil 34 which applies an equal and opposite force to the sleeve 20 of the fastener 18 by way of a shift washer 50.

The shift washer 50 has an upper portion 52 and a lower portion 54 which are concentrically arranged. The upper portion 52 and the lower portion 54 are joined by a frangible portion 56. The outer diameter of the upper portion 52 is slightly smaller than the inner diameter of the lower portion 54 of the shift washer 50.

As shown in FIG. 2, as the gripping member 32 pulls the stem 22 of the fastener 18, the anvil 34 pushes against the upper portion 52 of the shift washer 50. As shown in FIG. 3, when a predetermined push-pull force is reached, the frangible portion 56 of the shift washer 50 will fail and the anvil 34 will drive the upper portion 52 of the shift washer 50 inside the lower portion 54 and into engagement with a locking collar 38. The malleable locking collar 38 is driven into a cavity 44 between the sleeve 20 and the stem 22 to prevent disengagement of the stem 22 and the sleeve 20.

After installation, the stem 22 is broken at a reduced portion 22a to provide a finished installed fastener as shown in FIG. 4 and the shift washer 50 is discarded.

The shift washer 50 used in the Matuschek '123 patent is made by machining solid bar stock. During the machining process a lathe is used to create the desired outer diameters of the upper portion 52 and the lower portion 54 of the shift washer 50. A drill is used to form the desired inner diameters of the upper portion 52 and the lower portion 54 of the shift washer 50. Each of these machining steps adds expense and time to the production of the washer 36 resulting in a cost of approximately $0.09 to $0.13 per shift washer. Additionally, a substantial amount of scrap material results from the process of machining the shift washer 50.

In addition to the expense of machining the shift washer 50, problems are encountered when the shift washer 50 is assembled with the remaining fastener parts. Once machined, the shift washers 50 are placed in a hopper in preparation for assembly with the remaining fastener parts. Each shift washer 50 must be removed from the hopper and placed around the stem 22 of the fastener 18. Because the outer diameter of the upper portion 52 of the shift washer 50 is smaller than the inner diameter of the lower portion 54, the shift washers 50 often become nested with one another. Nesting occurs when the upper portion 52 of one shift washer 50 is inserted into the lower section 54 of another shift washer 50. In order for the blind fastener 18 to be properly assembled, the nested shift washers 50 must first be separated so that only one shift washer 50 is assembled with each blind fastener 18. When an automated process is used to assemble the blind fasteners 18, nesting becomes a more significant problem. The nesting of the shift washers 50 can cause assembly machinery to jam and production must be interrupted to remove the nested shift washers 50 from the assembly machinery.

The present invention provides a novel shift washer which overcomes the problems presented in the prior art and which provides additional advantages over the prior art. Such advantages will become clear upon a reading of the attached specification in combination with a study of the drawings.

### OBJECTS AND SUMMARY OF THE INVENTION

An object of the present invention is to provide a shift washer which is manufactured more cost efficiently than prior art shift washers.

Another object of the present invention is to provide a shift washer which enables easier assembly of the blind fastener than assembly of the prior art blind fasteners.

Yet another object of the present invention is to provide a shift washer which functions with greater consistency during use in the blind fastening system.

Briefly, and in accordance with the foregoing, the present invention discloses a novel shift washer for use in a blind fastening system. The shift washer of the present invention is not formed using a machining process but rather is wrapped from wire stock. Thus, the cost of manufacturing the shift washer of the present invention is significantly reduced. The shift washers can be created faster than the prior art shift washers and the process for creating the shift washers results in less waste. Additionally, the novel shift washer of the present invention can include a flange which prevents nesting of one shift washer with another shift washer.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a fragmentary cross-sectional view of a blind fastening system of the prior art, incorporating a shift washer, positioned relative to a pair of work pieces, shown in cross-section, which are to be fastened together;

FIG. 2 is a fragmentary cross-sectional view of the prior art blind fastening system of FIG. 1 at an intermediate stage of the installation process;

FIG. 3 is a fragmentary cross-sectional view of the prior art blind fastening system of FIG. 1 at a further intermediate stage of the installation process;

FIG. 4 is a fragmentary cross-sectional view of the prior art blind fastening system of FIG. 1 at the final stage of the installation process;

FIG. 5 is a perspective view of a shift washer of the present invention;

FIG. 6 is a perspective view of a wire stock which is used to make the shift washer of FIG. 5;

FIG. 7a is a perspective view of the wire stock and the mandrel and brace which are used to wrap the wire stock;

FIG. 7b is a perspective view of a partially wrapped shift washer and the mandrel and brace used to wrap the shift washer;

FIG. 8 is a cross-sectional view of the shift washer along line 8-8 of FIG. 5;

FIG. 9 is a perspective view of a second embodiment of the shift washer of the present invention;

FIG. 10 is a perspective view of the wire stock which is used to make the shift washer of FIG. 9;

FIG. 11 is a cross-sectional view of the shift washer of FIG. 9 along line 11-11 of FIG. 9;

FIG. 12 is a cross-sectional view of two shift washers of FIG. 9 positioned on top of one another;

FIG. 13 is a fragmentary cross-sectional view of a blind fastening system of the prior art, incorporating the second embodiment of the novel shift washer, positioned relative to a pair of work pieces, shown in cross-section, which are to be fastened together;

FIG. 14 is a fragmentary cross-sectional view of the blind fastening system of FIG. 13 at an intermediate stage of the installation process;

FIG. 15 is a fragmentary cross-sectional view of the blind fastening system of FIG. 13 at a further intermediate stage of the installation process; and

FIG. 16 is a fragmentary cross-sectional view of the blind fastening system of FIG. 13 at the final stage of the installation process.

### DETAILED DESCRIPTION OF THE ILLUSTRATED EMBODIMENT

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

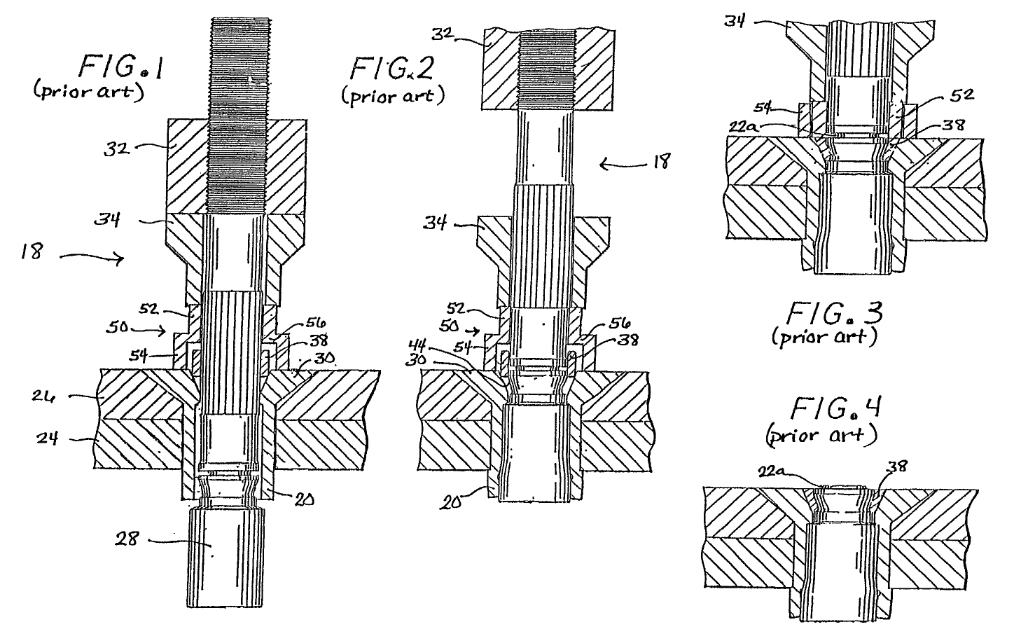

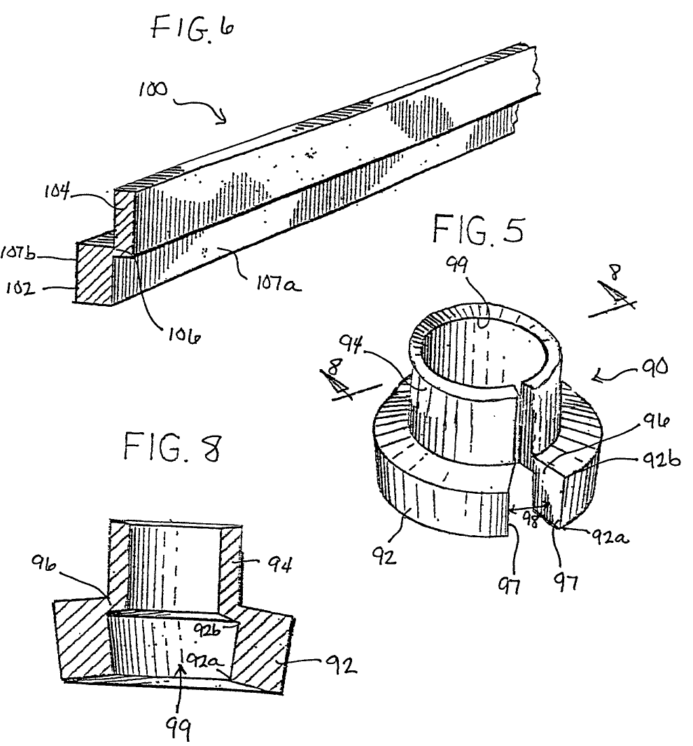

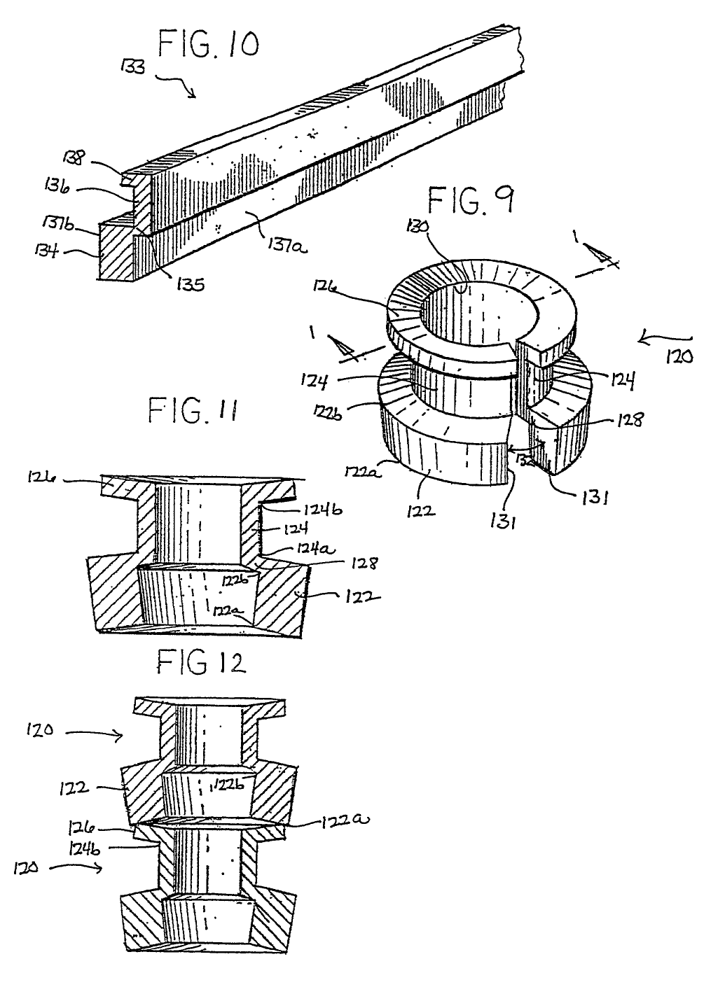

A first embodiment of the shift washer 90 of the present invention is shown in FIGS. 5-8 and a second embodiment of the shift washer 120 of the present invention is shown in FIGS. 9-16. The shift washers 90, 120 are used as a substitute for the shift washer 50 in the blind fastening system shown in FIGS. 1-4.

Attention is invited to the first embodiment of the shift washer 90 shown in FIGS. 5-8. As shown in FIG. 5, the shift washer 90 includes a cylindrically shaped tubular first portion 92 with a bottom end 92a and a top end 92b and a cylindrically shaped tubular second portion 94 with a bottom end 94a and a top end 94b. A central passageway 99 is provided through the center of the first and second portions 92, 94. The first portion 92 tapers outwardly from its bottom end 92a to its top end 92b, such that its inner and outer surfaces are tapered. The first portion 92 and the second portion 94 are axially aligned. The outer diameter of the second portion 94 is smaller than the inner diameter of the first portion 92 at its top end 92b. A frangible portion 96 joins the first portion 92 at its top end 92b to the second portion 94 at its bottom end 94a. A slot 98 extends through the first and second portions 92, 94 and is in communication with the passageway 99. Two free ends 97 are provided on either side of the slot 98.

Unlike the prior art shift washers which are machined, the shift washer 90 of the present invention is formed from wire stock which is wrapped. As shown in FIG. 6, the wire stock 100 used to form the shift washer 90 includes an elongated rectangular first portion 102, an elongated rectangular second portion 104 and an elongated frangible portion 106 which joins the first portion 102 and the second portion 104. Side 107a of the wire stock 100 will define the wall of the central passageway 99 through the shift washer 90 and side 107b of the wire stock 100 will form the exterior surface of the shift washer 90.

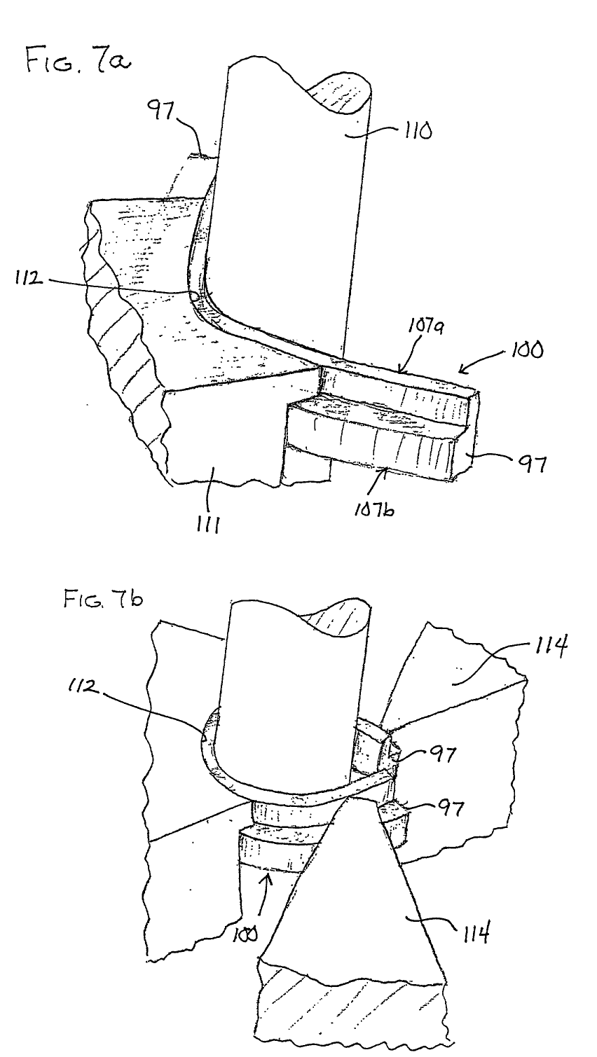

As shown in FIG. 7a, to form the shift washer 90, the wire stock 100 is cut to a predetermined length, creating two free ends 97. Side 107a of the wire stock 100 is placed against a mandrel 110. A brace 111 with a generally U-shaped groove 112 is placed against side 107b of the wire stock 100. As the mandrel 110 is brought within the U-shaped groove of the brace 111, the wire stock 100 is wrapped around the mandrel 110 so that side 107a of the wire stock 100 follows the curvature of the mandrel 110 and side 107b of the wire stock 100 follows the curvature of the U-shaped groove 112 of the brace 111. Two arms 114 are then used to force the two free ends 97 against the mandrel 110 to complete the wrapping of the shift washer 90 around the mandrel 110 as shown in FIG. 7b. Depending upon the length of the wire stock and the dimensions of the mandrel 110, the free ends 97 may or may not abut each other. The shift washer 90 is then removed from the mandrel 110 and is ready for assembly with the remaining parts of the fastening system.

As a result of the wrapping process, the first portion 92 of the washer 90 tapers inwardly as can be seen in FIG. 8. Thus, the inner diameter of the first portion 92 at the first end 92a is smaller than the inner diameter of the first portion 92 at the second end 92b. This tapering occurs because the material on side 107b of the wire stock 100 must extend a greater distance to form the exterior surface of the shift washer 90 than the material on side 107a of the wire stock 100 which provides the interior surface of the shift washer 90. The tapering of the first portion 92 also affects the slot 98. As a result of the tapering, the angle of the slot 98 is smaller at the first end 92a of the first portion 92 than the angle of the slot 98 at the second end 92b of the first portion 92. This tapering, however, does not negatively affect the function of the shift washer 90. It has been found that the angle of the slot 98 can be as large as sixty degrees (60°) without significantly impacting the performance of the shift washer 90.

Attention is invited to the second embodiment of the shift washer 120 of the present invention shown in FIGS. 9-16. As shown in FIG. 9, the shift washer 120 includes a cylindrically shaped tubular first portion 122, a cylindrically shaped tubular second portion 124, and a circularly shaped flange 126. The first portion 122, second portion 124, and flange 126 are axially aligned. A frangible portion 128 joins the first portion 122 to the second portion 124. The first portion 122 has a bottom end 122a and a top end 122b. The second portion 124 has a bottom end 124a and a top end 124b. The relative diameters of the first and second portions 122, 124 are identical to the relative diameters of the first and second portions 92, 94 of the shift washer 90 described above. The generally circular flange 126 extends outwardly from the top end 124b of the second portion 124. The generally circular flange 126 is angled relative to the second portion 124. A central passageway 130 is provided through the center of the first portion 122, the second portion 124, and the flange 126. The first portion 122 tapers outwardly from its bottom end 122a to its top end 122b, such that its inner and outer surfaces are tapered.

A slot 132 extends through the first portion 122, the second portion 124 and the flange 126 and is in communication with passageway 130. Two free ends 131 are provided on either side of the slot 132.

The shift washer 120 is formed from a piece of wire stock 133 as shown in FIG. 10 which is wrapped. The wire stock 133 includes an elongated rectangular first portion 134, an elongated rectangular second portion 136, an elongated frangible portion 135, and an elongated rectangular flange portion 138. Side 137a of the wire stock 132 will define the central passageway 130 through the shift washer 120 and side 137b of the wire stock 132 will form the exterior surface of the shift washer 120.

As with the first embodiment, to form the shift washer 120, the wire stock 132 is cut to a predetermined length, creating two free ends 131. The wire stock 100 is wrapped around a mandrel using a brace and arms as described above in reference to the first embodiment of the shift washer of the present invention.

As a result of the wrapping process, the first portion 122 of the washer 120 angles or tapers inwardly as can be seen in FIG. 11. Thus, the inner diameter of the first portion 122 at the first end 122a is smaller than the inner diameter of the first portion 122 at its second end 122b. As with the first embodiment, tapering of the first portion 122 causes tapering of the slot 132 such that the angle of the slot 132 at the first end 122a of the first portion 122 is smaller than the angle of the slot 132 at the second end 122b of the first portion 122. Tapering of the flange 126 also occurs. Before the wire stock 132 is wrapped, the flange portion 138 is perpendicular to the second portion 136. After wrapping, the angle of the flange 126 relative to the second portion 124 is greater than ninety degrees. As described with respect to the previous embodiment discussed above, this tapering does not affect the function or performance of the shift washer 120 when compared to machined shift washers.

The diameter of the flange 126 is greater than the inner diameter of the lower portion 122. As can be seen in FIG. 12, the diameter of the flange 126 relative to the inner diameter of the lower portion 122 of the shift washer 120, prevents one washer 120 from becoming nested with another washer 120.

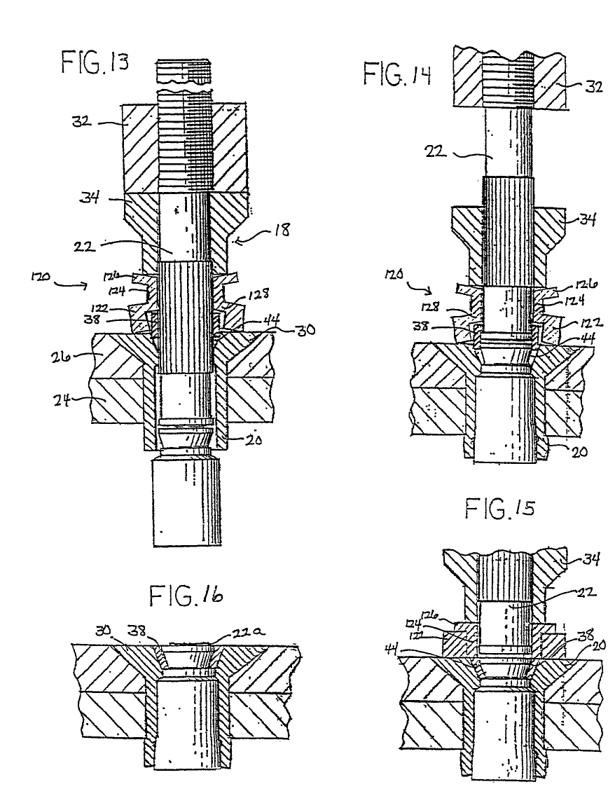

FIGS. 13-16 show the blind fastening system of the prior art, with the exception that the shift washer 120 of the present invention has been substituted for the prior art shift washer 50. Accordingly, identical reference numbers are provided for the remaining elements of the blind fastening system as are provided in FIGS. 1-4. While the installation of the fastener 18 is described using the shift washer 120, the second embodiment, it is to be understood that the identical installation process is performed when the first embodiment of the shift washer 90 is used.

As shown in FIG. 13, the stem 22 of the fastener is passed through the sleeve 20 and the central passageway 130 of the shift washer 120. The anvil 34 of the installation tool rests on the flange 126 of the shift washer 120 (if the first embodiment of the shift wash 90 is used, the anvil 34 rests on the upper end of the second portion 94).

As shown in FIG. 14, the installation of the fastener begins as the gripping member 32 pulls on the stem 22 of the fastener 18 and the anvil 34 applies an equal and opposite force on the sleeve 20 by way of the shift washer 120.

As shown in FIG. 15, the frangible portion 128 of the shift washer 120 fails when a predetermined push-pull force is reached. At this point, the anvil 34 drives the second portion 124 of shift washer 120 into engagement with the malleable locking collar 38. The malleable locking collar 38 is then driven into the cavity 44 between the sleeve 20 and the stem 22 to prevent disengagement of the stem 22 and the sleeve 20. Additionally, the stem 22 is drawn into the sleeve 20, causing the sleeve 20 to engage the opening in the material 24. The height of the second portion 124 of the shift washer 120 relative to the first portion 122 is sufficient to allow the second portion 124 to drive the locking collar 38 into the cavity 44 before the flange 126 contacts the upper end 122b of the first portion 122.

After installation, the stem 22 is broken at the reduced portion 22a to provide a finished installed fastener as shown in FIG. 16. Accordingly, installation of the blind fastener using the shift washer 120 of the present invention does not alter the method in which the fastener is installed.

As shown in FIGS. 1-4, the malleable locking collar 38 is designed to fill the gap 44 between the sleeve 20 and the stem 22. With the shift washer 120 of the present invention, because the shift washer 120 includes a slot 132, rather than filling the gap 44, a portion of the malleable locking collar 38 may bleed into the slot 132. The larger the slot 132, the more bleeding that will occur and the smaller the slot 132, the less bleeding will occur. Thus the smaller the slot 132, the closer the shift washer 120 will function to a machined shift washer. Additionally, if the slot 132 is small enough, the tapering which occurs due to wrapping can prevent bleeding of the malleable locking collar 38. The tapering of the first portion 122 may cause the free ends 131 near the bottom end 122a of the first portion 122 to contact each other. Thus, the slot 132 will be closed at the bottom end 122a of the first portion 122 and will prevent bleeding of the malleable locking collar 38 into the slot 132.

The process of forming the shift washers 90, 120 using the wrapping process of the present invention results in very little material waste. First, the wire stock 100, 133 can be cut precisely to the length desired to form a shift washer 90, 120 of the desired diameter. Second, the wire stock 100 is formed to provide the upper and lower portions 102, 104 of the shift washer 90. The wire stock 133 is formed to provide the lower and upper portions 122, 124 and the flange 126. The formation of the wire stock eliminates the need for drilling or for using a lathe to create the required inner and outer diameters. Thus, material is not lost to these processes. Additionally, time is not lost to these process. The reduction of waste and the simplified method of creating the shift washers 90, 120 results in a significant reduction in the cost of manufacturing the shift washers 90, 120. These estimated costs savings range from approximately thirty to forty percent of the manufacturing cost.

In addition to the cost benefits which are provided by the wrapped shift washers 90, 120, there are also structural benefits. The wire stock 100, 133 used to make the shift washers 90, 120 is generally purchased in spools of hundreds or thousands of feet. Because the shift washers 90, 120 used in the blind fastening systems are generally very small, dozens of shift washers 90, 120 can be formed from a single foot of wire stock. Because the material properties of the wire stock are generally consistent throughout the continuous spool, the material properties of shift washers made from that spool will also be consistent.

The material consistency is important for the consistent and reliable operation of the shift washers 90, 120. The shift washers 90, 120 are compressed during the installation of the blind fastener and the frangible sections 96, 135 are designed to fail when a predetermined compressive load is reached. The more consistency that exists in the material, the more consistently the frangible sections 96, 135 will fail when the pre-determined compressive load is reached. If too much force or too little force is required for the frangible portion to fail, improper installation of the blind fastener will result.

While preferred embodiments of the present invention are shown and described, it is envisioned that those skilled in the art may devise various modifications of the present invention without departing from the spirit and scope of the appended claims.

The invention claimed is:

1. A shift washer for use with a fastening system, said shift washer comprising:
a first portion having opposite first and second ends;
a second portion having opposite first and second ends, said second portion being attached to and extending from said second end of said first portion, said second portion being at least partially offset from said first portion; and
a frangible portion between said first portion and said second portion;
wherein said shift washer is formed by wrapping a material around a mandrel.

2. A shift washer as defined in claim 1, further including a flange attached to and extending outwardly from said second end of said second portion.

3. A shift washer as defined in claim 1, wherein the inner diameter of said first portion is larger than the outer diameter of said second portion.

4. A shift washer as defined in claim 2, wherein the outer diameter of said flange is larger than the inner diameter of said first portion.

5. A shift washer as defined in claim 1, wherein said material is wire.

6. A shift washer as defined in claim 1, wherein said shift washer further includes a slot.

7. A shift washer as defined in claim 6, wherein the angle of said slot is sixty degrees or less.

8. A shift washer as defined in claim 1, wherein the diameter of said first portion is smaller at its first end than at its second end.

9. A shift washer as defined in claim 2, wherein said flange is tapered and the angle between said flange and said second portion is larger than 90 degrees.

10. A method of forming a shift washer comprising the steps of:
forming a piece of wire to form a first portion, a second portion offset from said first portion and a frangible portion between said first portion and said second portion;
cutting said wire to a predetermined length to form two free ends;
providing a mandrel;
wrapping said wire around said mandrel.

11. A method of wrapping a shift washer as defined in claim 10, further including the step of forming said wire to include a flange.

12. A method of wrapping a shift washer as defined in claim 10, further comprising the step of placing said mandrel and said wire within a groove of a brace.

13. A method of wrapping a shift washer as defined in claim 10, further including the step of:
forcing said free ends against said mandrel such that said free ends are spaced apart from each other at a predetermined distance.
